(19) United States
(12) Patent Application Publication
(10) Pub. No.: US 2012/0040211 A1
(43) Pub. Date: Feb. 16, 2012

(54) GLASS FILM FOR LITHIUM ION BATTERY

(76) Inventors: Takashi Murata, Shiga (JP); Katsutoshi Fujiwara, Shiga (JP)

(21) Appl. No.: 13/202,151

(22) PCT Filed: Feb. 22, 2010
(86) PCT No.: PCT/JP2010/052623

§ 371 Date: Oct. 27, 2011

(30) Foreign Application Priority Data
Feb. 23, 2009 (JP) 2009-038725

(51) Int. Cl. H01M 10/02; H01M 16/00; B32B 17/00

(52) U.S. Cl. 429/9; 428/141; 429/122

(57) ABSTRACT

A glass film for a lithium ion battery has a thickness of 300 μm or less and a surface roughness (Ra) of 100 Å or less.

### TECHNICAL FIELD

The present invention relates to a glass film for a lithium ion battery, for example, a glass film suitable for a substrate (base material) of a lithium ion secondary battery mounted on an active IC card or the like.

### BACKGROUND ART

Lithium ion secondary batteries are widely used as power sources for mobile phones, PDAs, or digital cameras. In a lithium ion secondary battery, charge and discharge are realized by insertion and desorption of the lithium ions between a positive electrode and a negative electrode. For that reason, liquid electrolytes having high ion mobility have been used in conventional lithium ion secondary batteries.

However, liquid electrolytes are vulnerable to temperature change, and are liable to cause leakage. Accordingly, the liquid electrolytes still have a problem of durability to be solved. Further, the liquid electrolytes have a risk of ignition. In view of the above-mentioned circumstances, intensive studies have been made in recent years on attempts to develop solid electrolytes (see, for example, Patent Document 1).

Besides, when a solid electrolyte is used, the electrolyte can be formed into a thin film. As a result, the production of a lithium ion secondary battery having flexibility becomes possible, and the lithium ion secondary battery can be built-in an active IC card or the like.

### CITATION LIST

### Patent Document

[Patent Document 1] JP-A-2002-42863

### SUMMARY OF INVENTION

### Technical Problem

A substrate, on which the above-mentioned solid electrolyte is formed, is required to have flexibility and insulating property, and is also required to have high heat resistance because film formation of the solid electrolyte is carried out at high temperatures by using a sputtering method or the like. Moreover, the substrate is required to have a smooth surface because the thickness of the solid electrolyte film is very thin. In addition, the substrate is also required to be light in weight, when the substrate is built-in an active IC card or the like.

Hitherto, as a material for the substrate used for the above-mentioned applications, there has been used a plastic substrate or a metal substrate that is hard to be broken if being bent. However, those substrates yet have problems of, in addition to being insufficient in insulating property and heat resistance, being liable to decrease in film quality because of minute unevenness present on the surface thereof, and to cause deficiency such as deterioration of battery characteristics during repeated charge and discharge of the battery.

Thus, a technical object of the present invention is to provide a substrate which is excellent in insulating property, heat resistance, and surface smoothness, and also is lightweight, while having flexibility, thereby to enable to manufacture a lithium ion battery having flexibility and being good in battery characteristic or the like.

### Solution to Problem

The inventors of the present invention have made various studies. As a result, the inventors have found that the above-mentioned technical object can be solved by employing as a substrate a glass film having a thickness of 300 μm or less and controlling the surface roughness of the glass film. Thus, the present invention is proposed. That is, a glass film for a lithium ion battery of the present invention is characterized by having a thickness of 300 μm or less and a surface roughness (Ra) of 100 Å or less. Here, the term “surface roughness (Ra)” refers to a value obtained by measurement using a method in accordance with JIS B0601: 2001.

Use of the glass film enables the enhancement of insulating property and heat resistance of a substrate. In addition, when the thickness of the glass film becomes small, the flexibility of the substrate is improved and the substrate becomes lightweight. Besides, when the surface roughness (Ra) of the glass film becomes small, it is possible to enhance the quality of a solid electrolyte film, the battery characteristics of a lithium ion battery, or the like.

The glass film for a lithium ion battery of the present invention is preferable to having a surface roughness (Rp) of 10,000 Å or less. Here, the term “surface roughness (Rp)” refers to a value obtained by measurement using a method in accordance with JIS B0601: 2001.

The glass film for a lithium ion battery of the present invention is preferable to having a surface roughness (Rku) of 3 or less. Here, the term “surface roughness (Rku)” refers to a value obtained by measurement using a method in accordance with JIS B0601: 2001. It should be noted that the term “surface roughness (Ra, Rp, or Rku)” refers to a value obtained by measurement on any one of one surface and the other surface excluding the cutting surfaces (edge surfaces) of a glass film, that is, a value obtained by measurement on the effective surface of the glass film (surface on which a device such as a lithium ion battery is formed). Meanwhile, the surface roughness (Ra, Rp, or Rku) of a surface other than the effective surface of the glass film is not particularly limited, but the surface roughness is preferably in the range described above from the viewpoint of the production efficiency of a lithium ion battery or the like.

The glass film for a lithium ion battery of the present invention is preferable to having an unpolished surface. Thereby, the production efficiency and mechanical strength of the glass film can be enhanced.

The glass film for a lithium ion battery of the present invention is preferable to having a volume resistivity log ρ at 350° C. of 5.0Ω·cm or more. Here, the term “volume resistivity log ρ” refers to a value obtained by measurement based on a method of ASTM C657.

The glass film for a lithium ion battery of the present invention is preferable to having a strain point of 500° C. or more. Thereby, the glass film becomes hard to be deformed when the glass film undergoes a thermal treatment at high temperatures, and hence film formation temperature can be set high. As a result, the quality of a solid electrolyte film, a conductive film, or the like can be enhanced. Here, the term “strain point” refers to a value obtained by measurement based on a method of ASTM C366.

The glass film for a lithium ion battery of the present invention is preferable to having a thermal expansion coefficient at 30 to 380° C. of 30 to 100×10⁻⁷/° C. The phrase “thermal expansion coefficient at 30 to 380° C.” refers to an average value of the values obtained by measurement with a dilatometer in the temperature range of 30 to 380° C.

The glass film for a lithium ion battery of the present invention is preferable to having a density of 3.0 g/cm³ or less. Here, the term “density” refers to a value obtained by measurement using the known Archimedes' method.

The glass film for a lithium ion battery of the present invention is preferable to having a liquidus temperature of 1200° C. or less and/or a liquidus viscosity of 10^{4.5} dPa·s or more. Here, the term “liquidus temperature” refers to a value obtained by measuring a temperature at which crystals of glass are deposited after glass powders that passed through a standard 30-mesh sieve (having a sieve mesh size of 500 μm) and remained on a 50-mesh sieve (having a sieve mesh size of 300 μm) are placed in a platinum boat and kept for 24 hours in a gradient heating furnace. The term “liquidus viscosity” refers to a value obtained by measuring the viscosity of glass at a liquidus temperature using the platinum sphere pull up method.

The glass film for a lithium ion battery of the present invention is preferable to having a temperature at a viscosity of 10^{2.5} dPa·s of 1650° C. or less. Here, the phrase “temperature at a viscosity of 10^{2.5} dPa·s” refers to a value obtained by measurement using the platinum sphere pull up method.

The glass film for a lithium ion battery of the present invention is preferable to having a film area of 0.1 m² or more and having two or less surface projections per m². Here, the term “surface projection” refers to a value obtained by the following process. That is, while a glass film is irradiated with light of a fluorescent lamp in a dark room, rough visual inspection is performed using the reflected light. After that, a contact-type roughness meter is used to measure the height of profile peaks of a surface within a length of 1000 μm, and then, the number of profile peaks having a height difference (height of profile peak) of 1 μm or more between the tip of the profile peak and the surface (mean line) of the glass film is counted, and the resultant number is converted to the number per m² to calculate the value.

The glass film for a lithium ion battery of the present invention is preferable to having a water vapor permeation rate of 1 g/(m²·day) or less. Thereby, the solid electrolyte is easily prevented from deteriorating. Here, the term “water vapor permeation rate” refers to a value evaluated using a calcium method.

The glass film for a lithium ion battery of the present invention is preferable to having an oxygen permeation rate of 1 cc/(m²·day) or less. Thereby, the solid electrolyte is easily prevented from deteriorating. Here, the term “oxygen permeation rate” refers to a value evaluated using differential pressure-type gas chromatography (in accordance with JIS K7126).

The glass film for a lithium ion battery of the present invention is preferable to being formed by an overflow down-draw method. Thereby, the surface precision of the glass film can be enhanced.

The glass film for a lithium ion battery of the present invention can be formed by a slot down-draw method.

The glass film for a lithium ion battery of the present invention is preferable to being rolled into a roll shape.

The glass film for a lithium ion battery of the present invention is preferable to being fixed onto a supporting glass sheet having a thickness of 0.3 mm or more.

A lithium ion battery of the present invention can include the above-mentioned glass film for a lithium ion battery. Thereby, it is able to manufacture a lithium ion battery having flexibility and being good in battery characteristic or the like

A complex battery of the present invention can be formed by integrating the above-mentioned lithium ion battery with a solar cell. When a conventional solar cell is used outdoors, the solar cell can generate power only in the daytime, and hence power needs to be supplied from any other power source in the nighttime. However, when the above-mentioned lithium ion battery is integrated with a solar cell, extra power out of the power generated by the solar cell in the daytime can be stored in the lithium ion battery, and power thus can be supplied even in the nighttime.

The complex battery of the present invention can be formed by integrating the above-mentioned lithium ion battery with a thin-film solar cell. Thereby, flexibility can be given to the complex battery. Thus, the degree of freedom of the place at which the battery is installed is enhanced, and a complex solar cell can be made lightweight.

An OLED device of the present invention can include the above-mentioned lithium ion battery. Some conventional OLED devices are known to have flexibility, but because a battery portion does not have flexibility, when the battery portion is integrated with an OLED device, the flexibility of the OLED device is lost. Due to the above-mentioned reason, a battery portion was separately connected to a conventional OLED device. However, when the above-mentioned structure is employed in an OLED device, the flexibility of the device is not impaired even in the case where a battery portion is integrated, and hence development to a flexible display, a flexible light, or the like becomes possible in the real sense.

### ADVANTAGEOUS EFFECTS OF INVENTION

The glass film for a lithium ion battery of the present invention is excellent in insulating property, heat resistance, and surface smoothness, and moreover, is lightweight while having flexibility. As a result, it is possible to manufacture a lithium ion battery having flexibility and being good in battery characteristic or the like.

### BRIEF DESCRIPTION OF DRAWINGS

FIG. 1 is a conceptual diagram for describing an overflow down-draw method.

FIG. 2 is a conceptual diagram for describing a production method for a glass film.

### DESCRIPTION OF EMBODIMENTS

The thickness of the glass film for a lithium ion battery of the present invention is preferably 300 μm or less, 200 μm or less, 150 μm or less, 100 μm or less, 80 μm or less, 60 μm or less, or 40 μm or less, or particularly preferably 30 μm or less. When the thickness of the glass film is more than 300 μm, the flexibility is more likely to decrease and reducing the weight of the glass film becomes difficult, and hence reducing the weight of, for example, an IC card and MEMS also becomes difficult. However, if the thickness of the glass film is too small, the mechanical strength of the glass film decreases, and hence the thickness of the glass film is preferably 5 μm or more, 10 μm or more, or particularly preferably 15 μm or more. It should be noted that when the thickness of the glass film is controlled in the above-mentioned range, development to a roll-to-roll process becomes possible, and as a result, the productivity of the lithium ion battery can be enhanced.

The surface roughness Ra of the glass film for a lithium ion battery of the present invention is preferably 100 Å or less, 20 Å or less, 10 Å or less, 5 Å or less, 4 Å or less, 3 Å or less, or particularly preferably 2 Å or less. If the surface roughness Ra is more than 100 Å, the quality of a solid electrolyte film formed on the glass film is more likely to decrease.

The surface roughness Rp of the glass film for a lithium ion battery of the present invention is preferably 10000 Å or less, 5000 Å or less, 3000 Å or less, 1000 Å or less, or 100 Å or less, or particularly preferably 10 Å or less. If the surface roughness Rp is more than 10000 Å, unnecessary reaction occurs at surface projections of the surface when charge and discharge are repeated, and as a result, deterioration of battery characteristics is more likely to occur.

The surface roughness Rku of the glass film for a lithium ion battery of the present invention is preferably 3 or less, 2 or less, or particularly preferably 1 or less. If the surface roughness Rku is more than 3, unnecessary reaction occurs at surface projections of the surface when charge and discharge are repeated, and as a result, deterioration of battery characteristics is more likely to occur.

The glass film for a lithium ion battery of the present invention preferably has an unpolished surface, and more preferably has an effective surface wholly unpolished. Thereby, the production efficiency of the glass film is enhanced, and the situation where the mechanical strength of the glass film decreases because of polishing flaws is easily prevented.

The glass film for a lithium ion battery of the present invention preferably has a volume resistivity logo at 350° C. of preferably 5.0Ω·cm or more, 8.0Ω·cm or more, 10.0Ω·cm or more, or particularly preferably 12.0Ω·cm or more. If the volume resistivity logo at 350° C. is too low, the insulating property of the glass film is more likely to decrease, and battery characteristics are more likely to decrease.

The glass film for a lithium ion battery of the present invention preferably has a strain point of 500° C. or more. The strain point is a characteristic serving as an index for heat resistance. If the strain point is low, deformation of the glass film may occur when a solid electrolyte is formed into a film. Meanwhile, also in a complex battery in which a lithium ion battery is integrated with a solar cell, the formation temperature of a film constituting the solar cell needs to be high, and hence the glass film is required to have heat resistance. The preferred range of the strain point is preferably 550° C. or more, 580° C. or more, 600° C. or more, or 620° C. or more, or particularly preferably 650° C. or more.

The glass film for a lithium ion battery of the present invention preferably has a thermal expansion coefficient at 30 to 380° C. of 30 to 100×10⁻⁷/° C. If the thermal expansion coefficient is too high, the glass film is more likely to break because of a thermal shock given during a film formation process or the like. In the meantime, if the thermal expansion coefficient is too low, the thermal expansion coefficient of the glass film does not easily match that of a solid electrolyte formed on the glass film. The preferred range of the thermal expansion coefficient therefore is preferably 30 to 90×10⁻⁷/° C., 30 to 80×10⁻⁷/° C., or 30 to 40×10⁻⁷/° C., or particularly preferably 32 to 40×10⁻⁷/° C.

The glass film for a lithium ion battery of the present invention preferably has a density of preferably 3.0 g/cm³ or less, 2.8 g/cm³ or less, 2.7 g/cm³ or less, 2.6 g/cm³ or less, or 2.5 g/cm³ or less, or particularly preferably 2.48 g/cm³ or less. As the density is smaller, the weight of the glass film can be more reduced, and hence, the weight of, for example, an IC card and MEMS can also be reduced.

The glass film for a lithium ion battery of the present invention has a temperature at a viscosity of 10^{2.5} dPa·s of preferably 1600° C. or less, or 1580° C. or less, or particularly preferably 1550° C. or less. The temperature at a viscosity of 10^{2.5} dPa·s corresponds to the melting temperature of glass. As the temperature at a viscosity of 10^{2.5} dPa·s is lower, glass can be melted at a lower temperature. Thus, as the temperature at a viscosity of 10^{2.5} dPa·s is lower, glass production facilities such as a melting furnace receive a more reduced burden, and at the same time, the bubble-less quality of the glass film is improved. As a result, the glass film can be produced at a low cost.

The glass film for a lithium ion battery of the present invention has a liquidus temperature of preferably 1200° C. or less, 1150° C. or less, 1130° C. or less, 1110° C. or less, or 1100° C. or less, or particularly preferably 1080° C. or less. If the liquidus temperature is too high, forming by an overflow down-draw method becomes difficult, and hence increasing the surface precision of the glass film becomes difficult.

The glass film for a lithium ion battery of the present invention has a liquidus viscosity of preferably 10^{4.5} dPa·s or more, 10^{5.0} dPa·s or more, 10^{5.3} dPa·s or more, or 10^{5.5} dPa·s or more, or particularly preferably 10^{5.6} dPa·s or more. If the liquidus viscosity is too low, forming by an overflow down-draw method becomes difficult, and hence increasing the surface precision of the glass film becomes difficult.

The glass film for a lithium ion battery of the present invention has a Young's modulus of preferably 10 GPa or more, 30 GPa or more, 50 GPa or more, 60 GPa or more, or 70 GPa or more, or particularly preferably 73 GPa or more. As the Young's modulus is higher, the degree of the warpage generated by the film formed on the glass film can be reduced more easily. Meanwhile, if the Young's modulus is too high, the stress generated when the glass film is bent becomes large, resulting in easy breakage of the glass film. The Young's modulus therefore is preferably 90 GPa or less, 85 GPa or less, or 80 GPa or less, or particularly preferably 78 GPa or less. Here, the term “Young's modulus” refers to a value obtained using measurement by a bending resonance method.

The glass film for a lithium ion battery of the present invention has a film area of 0.1 m² or more and has preferably two or less surface projections per m², preferably one or less surface projections per m², particularly preferably zero surface projection per m². For the lithium ion battery, when minute unevenness is present on the glass film, the activity of a battery reaction varies locally. In particular, if there is a precipitous projection, unusual reaction occurs at that portion, resulting in the tendencies that battery characteristics deteriorate, reliability of the battery decreases, charge and discharge characteristics decrease, for example.

The glass film for a lithium ion battery of the present invention has a water vapor permeation rate of preferably 1 g/(m²·day) or less, 0.1 g/(m²·day) or less, 0.01 g/(m²·day) or less, 0.001 g/(m²·day) or less, 0.0001 g/(m²·day) or less, 0.00001 g/(m²·day) or less, or 0.000001 g/(m²·day) or less, or particularly 0.0000001 g/(m²·day) or less. When a solid electrolyte used for the lithium ion battery reacts with moisture in the air, characteristics thereof remarkably deteriorate. Thus, the glass film preferably has a lower water vapor permeation rate in order to prevent the solid electrolyte from deteriorating in characteristics.

The glass film for a lithium ion battery of the present invention has an oxygen permeation rate of preferably 1 cc/(m²·day) or less, 0.1 cc/(m²·day) or less, 0.01 cc/(m²·day) or less, 0.001 cc/(m²·day) or less, 0.0001 cc/(m²·day) or less, 0.00001 cc/(m²·day) or less, or 0.000001 cc/(m²·day) or less, or particularly 0.0000001 cc/(m²·day) or less. When a solid electrolyte used for the lithium ion battery reacts with oxygen in the air, characteristics thereof remarkably deteriorate. Thus, the glass film preferably has a lower oxygen permeation rate in order to prevent the solid electrolyte from deteriorating in characteristics.

The glass film for a lithium ion battery of the present invention has flexibility. The glass film for a lithium ion battery of the present invention has a possible minimum curvature radius of preferably 200 mm or less, 150 mm or less, 100 mm or less, or 50 mm or less, or particularly preferably 30 mm or less. As the possible minimum curvature radius is smaller, the flexibility is improved more.

The glass film for a lithium ion battery of the present invention preferably contains, as a glass composition in terms of mass %, 40 to 70% of SiO₂, 1 to 30% of Al₂O₃, 0 to 15% of B₂O₃, and 0 to 15% of MgO+CaO+SrO+BaO (total amount of MgO, CaO, SrO, and BaO). The reasons for determining the range of the glass composition as described above is mentioned below.

SiO₂ is a component for forming the network of glass, and the content of SiO₂ is 40 to 70%, preferably 50 to 67%, more preferably 52 to 65%, still more preferably 55 to 63%, or particularly preferably 56 to 63%. If the content of SiO₂ is too large, the meltability and the formability decrease and the thermal expansion coefficient becomes too low, and as a result, the thermal expansion coefficient of the glass film does not easily match that of peripheral materials such as a solid electrolyte. Meanwhile, if the content of SiO₂ is too small, vitrification is not likely to occur and the thermal expansion coefficient becomes too high, and thus the thermal shock resistance is more likely to decrease.

Al₂O₃ is a component for raising the strain point and the Young's modulus, and the content of Al₂O₃ is 1 to 30%. If the content of Al₂O₃ is too large, devitrified crystals are easily deposited in glass, and as a result, forming by an overflow down-draw method or the like becomes difficult to conduct. In addition, if the content of Al₂O₃ is too large, the thermal expansion coefficient becomes too low, and as a result, the thermal expansion coefficient of the glass film does not easily match that of peripheral materials such as a solid electrolyte, or the viscosity at high temperature becomes too large, and as a result, melting glass becomes difficult. On the other hand, if the content of Al₂O₃ is too small, the strain point decreases, and desired heat resistance is not easily provided. In view of the above, the upper limit range of Al₂O₃ is preferably 20% or less, 19% or less, 18% or less, or 17% or less, or particularly preferably less than 16.8%. Meanwhile, the lower limit range of Al₂O₃ is preferably 2% or more, 4% or more, 5% or more, 10% or more, or 11% or more, or particularly preferably 14% or more.

B₂O₃ is a component for lowering the liquidus temperature, the viscosity at high temperature, and the density. If the content of B₂O₃ is too large, the water resistance decreases and the phase separation of glass is more likely to occur. Thus, the content of B₂O₃ is 0 to 15%, preferably 1 to 15%, 3 to 13%, or 5 to 12%, or particularly preferably 7 to 11%.

MgO+CaO+SrO+BaO is a component for enhancing the meltability and the formability, and for raising the strain point and the Young's modulus. If the content of MgO+CaO+SrO+BaO is too large, the density and the thermal expansion coefficient become too high, or the denitrification resistance is more likely to decrease. Thus, the content of MgO+CaO+SrO+BaO is 0 to 15%, preferably 1 to 15%, 2 to 15%, 3 to 15%, or 5 to 14%, or particularly preferably 8 to 13%.

MgO is a component for lowering the viscosity at high temperature, leading to the enhancement of the meltability and the formability, or for raising the strain point and the Young's modulus. However, if the content of MgO is too large, the density and the thermal expansion coefficient become too high, or the glass is more likely to denitrify. Thus, the content of MgO is 0 to 6%, 0 to 3%, 0 to 2%, or 0 to 1%, or particularly preferably 0 to 0.6%.

CaO is a component for lowering the viscosity at high temperature, leading to the enhancement of the meltability and the formability, or for raising the strain point and the Young's modulus. In addition, CaO has the higher effect of increasing the devitrification resistance among alkaline-earth metal oxides. However, if the content of CaO is too large, the density and the thermal expansion coefficient become too high, or the balance of components in the glass composition is lost, and on the contrary, the devitrification of glass is more likely to occur. Thus, the content of CaO is preferably 0 to 12%, 0.1 to 12%, 3 to 10%, 5 to 9%, or 6 to 9%, or particularly preferably 7 to 9%.

SrO is a component for lowering the viscosity at high temperature, leading to the enhancement of the meltability and the formability, or for raising the strain point and the Young's modulus. The content of SrO is preferably 0 to 10%. If the content of SrO is too large, the density and the thermal expansion coefficient become too high, or the devitrification of glass is more likely to occur. The content of SrO is preferably 5% or less, 3% or less, 1% or less, 0.5% or less, or 0.2% or less, or particularly preferably 0.1% or less.

BaO is a component for lowering the viscosity at high temperature, leading to the enhancement of the meltability and the formability, or for raising the strain point and the Young's modulus. The content of BaO is preferably 0 to 10%. If the content of BaO is too large, the density and the thermal expansion coefficient become too high, or the devitrification of glass is more likely to occur. The content of BaO is preferably 5% or less, 3% or less, 1% or less, 0.8% or less, 0.5% or less, or 0.2% or less, or particularly preferably 0.1% or less.

The glass composition may be formed of only the above-mentioned components. However, other components may be added up to at 30% or less, or preferably at 20% or less to the extent that the characteristics of glass are not largely impaired.

Li₂O is a component for lowering the viscosity at high temperature, leading to the improvement of the meltability and the formability, and is also a component for raising the Young's modulus. However, if the content of Li₂O is too large, the liquidus viscosity lowers, and as a result, the devitrification of glass is more likely to occur, and the thermal expansion coefficient becomes too high, with the result that the thermal shock resistance decreases, and the thermal expansion coefficient of the glass film does not easily match that of peripheral materials such as a solid electrolyte. In addition, if the content of Li₂O is too large, the viscosity at low temperature lowers excessively, leading to the difficulty in obtaining desired heat resistance. Thus, the content of Li₂O is preferably 5% or less, 2% or less, 1% or less, or 0.5% or less, or particularly preferably 0.1% or less. Being substantially free of Li₂O, in other words, containing Li₂O at less than 0.01% is most preferred.

Na₂O is a component for lowering the viscosity at high temperature, leading to the improvement of the meltability and the formability. However, if the content of Na₂O is too large, the thermal expansion coefficient becomes too high, with the result that the thermal shock resistance decreases, and the thermal expansion coefficient of the glass film does not easily match that of peripheral materials such as a solid electrolyte. In addition, if the content of Na₂O is too large, the strain point decreases excessively, and the balance of compositions in the glass composition is lost, and on the contrary, devitrification resistance of glass tends to decrease. Thus, the content of Na₂O is preferably 5% or less, 2% or less, 1% or less, or 0.5% or less, or particularly preferably 0.1% or less. Being substantially free of Na₂O, in other words, containing Na₂O at less than 0.01% is most preferred.

K₂O is a component for lowering the viscosity at high temperature, leading to the enhancement of the meltability and the formability, and is also a component for raising devitrification resistance. The content of K₂O is preferably 0 to 15%. If the content of K₂O is too large, the thermal expansion coefficient becomes too high, with the result that the thermal shock resistance decreases, and the thermal expansion coefficient of the glass film does not easily match that of peripheral materials such as a solid electrolyte. In addition, the strain point decreases excessively, and the balance of compositions in the glass composition is lost, and in reverse, devitrification resistance of glass tends to decrease. Thus, the upper limit range of K₂O is preferably 10% or less, 9% or less, 8% or less, 3% or less, or 1% or less, or particularly preferably 0.1% or less.

If the total content of alkali metal oxides (Li₂O, Na₂O, and K₂O) is too large, the devitrification of glass is more likely to occur, and the thermal expansion coefficient becomes too high, with the result that the thermal shock resistance decreases, and the thermal expansion coefficient of the glass film does not easily match that of peripheral materials such as a solid electrolyte. In addition, if the total content of the alkali metal oxides is too large, the strain point decreases excessively, and besides, the viscosity around the liquidus temperature decreases, resulting in the difficulty in securing the high liquidus viscosity in some cases. In addition, if the total content of the alkali metal oxides is too large, the volume resistivity of the glass film is more likely to decrease. The total content of the alkali metal oxides is preferably 20% or less, 15% or less, 10% or less, 8% or less, 5% or less, 3% or less, or 1% or less, or particularly preferably 0.1% or less.

ZnO is a component for lowering the viscosity at high temperature without lowering the viscosity at low temperature. However, if the content of ZnO is too large, the phase separation of glass occurs, the devitrification resistance of glass decreases, and the density of glass becomes too high. Thus, the content of ZnO is preferably 8% or less, 6% or less, or 4% or less, or particularly preferably 3% or less.

ZrO₂ has the effect of raising the Young's modulus and the strain point and also has the effect of lowering the viscosity at high temperature. Note that if the content of ZrO₂ is too large, the devitrification resistance extremely decreases in some cases. Thus, the content of ZrO₂ is preferably 0 to 10%, 0.0001 to 10%, 0.001 to 9%, 0.01 to 5%, or 0.01 to 0.5%, or particularly preferably 0.01 to 0.1%.

It is possible to add as a fining agent one kind or two or more kinds selected from the group consisting of As₂O₃, Sb₂O₃, SnO₂, CeO₂, F, SO₃, and Cl at 0.001 to 3%. Note that because it is pointed out that As₂O₃ and Sb₂O₃ cause an environmental problem, the content of each of these components is limited to preferably less than 0.1%, or particularly preferably less than 0.01%. In addition, one kind or two or more kinds selected from the group consisting of SnO₂, SO₃, and Cl are preferred as the fining agent. The total content of these components is preferably 0.001 to 3%, 0.001 to 1%, or 0.01 to 0.5%, or particularly preferably 0.05 to 0.4%.

Rare-earth oxides such as Nb₂O₅ and La₂O₃ are components for raising the Young's modulus. However, the rare-earth oxides themselves are expensive as materials, and if the rare-earth oxides are added in the glass composition in large amounts, the denitrification resistance is more likely to decrease. Thus, the content of the rare-earth oxides is preferably 3% or less, 2% or less, 1% or less, or 0.5% or less, or particularly preferably 0.1% or less.

It is pointed out that substances such as PbO and Bi₂O₃ cause an environmental problem, and hence the content of these substances is preferably restricted to less than 0.1%.

The glass film for a lithium ion battery of the present invention can be produced by blending raw glass materials so as to obtain a desired glass composition, supplying the raw glass materials to a continuous melting furnace, subjecting the raw glass materials to heating and melting at 1500 to 1600° C., followed by fining, and then feeding the molten glass into a forming apparatus to form and anneal. In addition, the glass film for a lithium ion battery of the present invention can be formed by any of various methods such as a down-draw method (overflow down-draw method, slot down-draw method, and redraw method), a float method, a rollout method, and a press method.

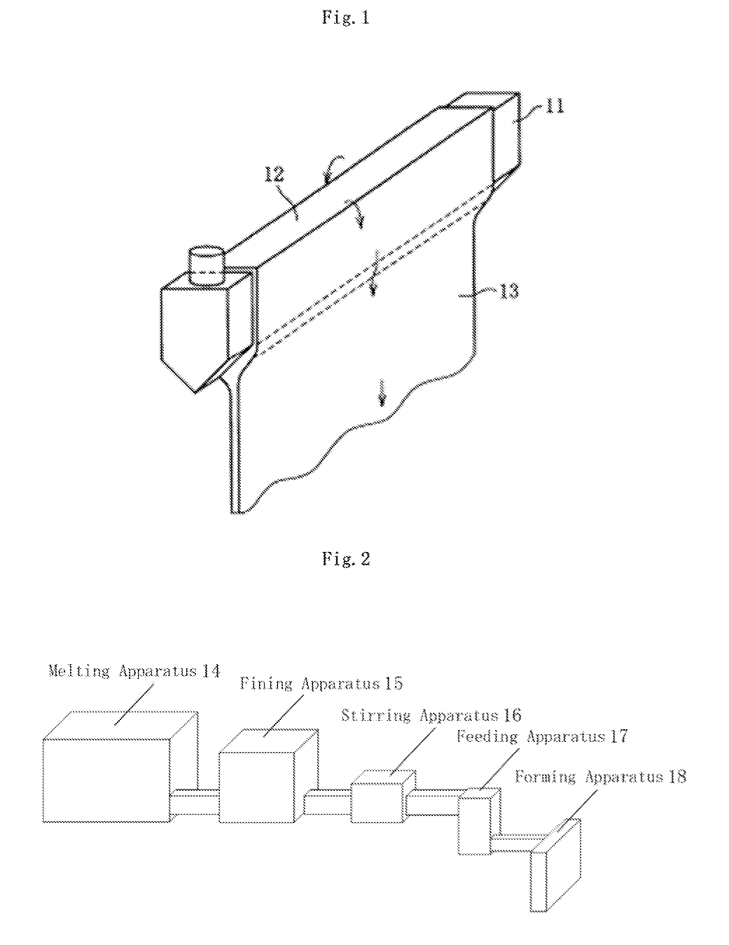

The glass film for a lithium ion battery of the present invention is preferably formed by a slot down-draw method or an overflow down-draw method. In particular, when the glass film is formed by the overflow down-draw method, the surface to be a surface of the glass film is formed in the state of a free surface without contacting a trough-shaped refractory, and hence it is possible to increase the surface precision of the glass film without being polished. Here, the term “overflow down-draw method” refers to a method in which as illustrated in FIG. 1, a molten glass 12 is caused to overflow from both sides of a heat-resistant trough-shaped refractory 11. The overflowed molten glass 12 is subjected to down-draw downward while being joined at the lower end of the trough-shaped refractory 11, to thereby obtain a glass film 13. The structure and material of the trough-shaped refractory 11 are not limited as long as a desired size and a desired surface quality can be realized. Further, a means for applying force during the down-draw is not particularly limited. For instance, such a means may be employed in that the glass film 13 is drawn by heat-resistant rolls each of which has a sufficiently large width and rotates while being contact with the glass film 13. Or such a means may be employed in that the glass film 13 is drawn by multiple pairs of heat-resistant rolls each of which rotates while being contact with only the vicinity of the edge surface of the glass film 13. It should be noted that when the liquidus temperature is 1200° C. or less and the liquidus viscosity is 10^{4.0} dPa·s or more, it is possible to produce a glass film by an overflow down-draw method.

When the glass film for a lithium ion battery of the present invention is shipped in the form of individual substrate, it is preferred that the glass film be supplied to a production process of a lithium ion battery or the like (including a complex solar cell or the like) in the state of the glass film being fixed to a supporting glass sheet, particularly in the state of the glass film being adhered to a supporting glass sheet, and be finally detached from the supporting glass sheet. Thereby, handling ability of the glass film can be enhanced, so that a positioning error, a shift in patterning, or the like become easy to be prevented. As a result, the production efficiency of the lithium ion battery or the like can be enhanced. Meanwhile, in the supporting glass sheet, the surface on which the glass film is fixed has a surface roughness (Ra) of preferably 100 Å or less, 20 Å or less, 10 Å or less, 5 Å or less, 4 Å or less, or 3 Å or less, or particularly preferably 2 Å or less. Thereby, the glass film and the supporting glass sheet can be fixed with each other without the use of any adhesive or the like, and when even one portion of the glass film can be detached from the supporting glass sheet, subsequently in succession, the entirety of the glass film can be detached from the supporting glass sheet. Further, the supporting glass sheet is preferably produced by an overflow down-draw method. Thereby, the surface precision of the supporting glass sheet can be increased. In addition, the supporting glass sheet has a strain point of preferably 500° C. or more, 550° C. or more, 580° C. or more, 600° C. or more, or 620° C. or more, or particularly preferably 650° C. or more. Thereby, the supporting glass sheet is hard to become deformed during heat treatment for film formation process (for example, formation of a solid electrolyte film and a conductive film such as FTO film). It should be noted that the supporting glass sheet has a thickness of preferably 0.3 mm or more, or particularly preferably 0.5 mm or more, in order to prevent its curvature and breakage. In addition, alkali-free glass, borosilicate glass, or the like can be used as a material for the supporting glass sheet.

The glass film for a lithium ion battery of the present invention is preferably supplied in the form of a glass roll in order to increase production efficiency. When the glass film of the present invention is formed into a roll shape, the glass film can be applied to so-called roll-to-roll process. Development to such the roll-to-roll process is effective on the production of a lithium ion battery or the like with good efficiency at a low cost.

It is preferred that a lithium ion battery produced using the glass film of the present invention be integrated with a solar cell to make a complex solar cell. When a conventional solar cell is, for instance, used outdoors, the solar cell can generate power only in the daytime, and hence power needs to be supplied from any other power source in the nighttime. However, when the above-mentioned lithium ion battery is integrated with the solar cell, extra power out of the power generated by the solar cell in the daytime can be stored in the lithium ion battery, and power thus can be supplied even in the nighttime. In addition, when such the solar cell is of a thin-film compound solar cell, a complex solar cell can be given flexibility and lightness, with the result that the degree of freedom of the place at which the complex solar cell is installed is enhanced, and moreover, the battery can be developed into new applications such as a mobile application.

The complex solar cell of the present invention may be formed by laminating a glass film, a lithium ion battery, and a solar cell in the stated order, or formed by laminating a glass film, a solar cell, and a lithium ion battery in the stated order. When the former structure is employed, the smooth surface of the glass film can be directly utilized, contributing to the enhancement of the performance of the lithium ion battery. Meanwhile, when the latter structure is employed, because the solar cell is formed earlier, it is possible to avoid the situation in which heat treatment during film formation for the solar cell, such as thin-film formation, gives an influence on the performance of the lithium ion battery. Further, more preferred is the structure in which a lithium ion battery and a solar cell are formed on a glass film, and then another glass film is arranged thereon so that these opposite glass films are sealed with each other. In particular, in the case of the structure in which the glass film, the lithium ion battery, and the solar cell are laminated in the stated order, a transparent cover is needed on the opposite surface, and hence preferred is the structure in which another glass film is arranged on the opposite surface to be sealed with the opposed the glass film. Further, it is also possible to form a solar cell on one side of the glass film of the present invention and a lithium ion battery on the other side. Besides, it is also possible to form an OLED device or any of various electronic devices at the same time on such the complex battery.

### Example 1

Hereinafter, the present invention is described based on examples.

Tables 1 and 2 show examples (Sample Nos. 1 to 10) and comparative examples (Sample No. 11) of the present invention.

TABLE 1

| | | Example | | | | | |
|---|---|---|---|---|---|---|---|
| | | No. 1 | No. 2 | No. 3 | No. 4 | No. 5 | No. 6 |
| Glass | SiO₂ | 59.8 | 63.7 | 59.2 | 62.8 | 64 | 60 |
| composition | Al₂O₃ | 17 | 16 | 15 | 17 | 16 | 17 |
| (mass %) | B₂O₃ | 10 | 10 | 10 | 10 | 10 | 7 |
| | MgO | — | — | — | 1 | — | 3 |
| | CaO | 8 | 8 | 6 | 8 | 7 | 4 |
| | SrO | 5 | 1 | 6 | 1 | 1 | 8 |
| | BaO | — | 1 | 2 | — | — | 1 |
| | ZnO | — | — | 0.5 | — | 1 | — |
| | Sb₂O₃ | — | — | 1 | — | 1 | — |
| | SnO₂ | 0.2 | 0.3 | 0.3 | 0.2 | — | — |

| | | | | | | |
|---|---|---|---|---|---|---|
| Density (g/cm³) | 2.46 | 2.39 | 2.50 | 2.39 | 2.38 | 2.50 |
| Thermal expansion | 38 | 32 | 38 | 33 | 31 | 37 |
| coefficient | | | | | | |
| (×10⁻⁷/° C.) | | | | | | |
| Ps (° C.) | 650 | 665 | 650 | 660 | 660 | 670 |
| Ta (° C.) | 710 | 725 | 710 | 720 | 730 | 720 |
| Ts (° C.) | 940 | 985 | 950 | 970 | 980 | 950 |
| 10^{4.0} dPa · s (° C.) | 1270 | 1320 | 1280 | 1290 | 1320 | 1270 |
| 10^{3.0} dPa · s (° C.) | 1430 | 1500 | 1460 | 1460 | 1500 | 1430 |
| 10^{2.5} dPa · s (° C.) | 1530 | 1610 | 1560 | 1560 | 1600 | 1530 |
| Liquidus temperature | 1084 | 1100 | 1080 | 1100 | 1100 | 1150 |
| (° C.) | | | | | | |
| Liquidus viscosity | 5.7 | 6.0 | 6.0 | 5.8 | 6.0 | 5.0 |
| (dPa · s) | | | | | | |
| Young's modulus | 73 | 70 | 70 | 73 | 70 | 77 |
| (GPa) | | | | | | |
| Surface roughness Ra | 2 | 2 | 2 | 2 | 2 | 2 |
| (Å) | | | | | | |
| Surface roughness Rp | 3 | 3 | 6 | 3 | 3 | 3 |
| (Å) | | | | | | |
| Surface roughness | 2 | 2 | 2 | 2 | 2 | 2 |
| Rku | | | | | | |
| Volume resistivity | 12 | 11.5 | 12 | 11 | 11 | 12 |
| Logρ (Ω · cm) 350° C. | | | | | | |
| Water vapor | 0.000001 | 0.000001 | 0.000001 | 0.000001 | 0.000001 | 0.000001 |
| permeation rate | or less | or less | or less | or less | or less | or less |
| (g/(m² · day)) | | | | | | |
| Oxygen permeation | 0.1 or | 0.1 or | 0.1 or | 0.1 or | 0.1 or | 0.1 or |
| rate (g/(m² · day)) | less | less | less | less | less | less |
| Surface projection | 0 | 0 | 0 | 0 | 0 | 0 |
| (piece/m²) | | | | | | |

TABLE 2

| | | | | | | Comparative |
|---|---|---|---|---|---|---|
| | | Example | | | | Example |
| | | No. 7 | No. 8 | No. 9 | No. 10 | No. 11 |
| Glass | SiO₂ | 60.7 | 61 | 51 | 62 | 71 |
| composition | Al₂O₃ | 16 | 15 | 10 | 17 | 2 |
| (mass %) | B₂O₃ | 11 | 10 | 13 | 9 | — |
| | MgO | 1 | 1 | — | 3 | 4 |
| | CaO | 6 | 5 | — | 5 | 9 |
| | SrO | 3 | 3 | — | — | — |
| | BaO | 2 | 5 | 24 | 3 | — |
| | Na₂O | — | — | — | — | 13 |
| | K₂O | — | — | — | — | 1 |
| | Sb₂O₃ | — | 2 | 2 | 1 | — |
| | SnO₂ | 0.3 | — | — | — | — |

| | | | | | |
|---|---|---|---|---|---|
| Density (g/cm³) | 2.42 | 2.5 | 2.73 | 2.4 | 2.50 |
| Thermal expansion | 32 | 37 | 45 | 33 | 85 |
| coefficient | | | | | |
| (×10⁻⁷/° C.) | | | | | |
| Ps (° C.) | 650 | 640 | 600 | 650 | 510 |
| Ta (° C.) | 710 | 698 | 650 | 700 | 551 |
| Ts (° C.) | 960 | 950 | 860 | 950 | 735 |
| 10^{4.0} dPa · s (° C.) | 1290 | 1290 | 1210 | 1270 | 1033 |
| 10^{3.0} dPa · s (° C.) | 1460 | 1460 | 1400 | 1430 | 1209 |
| 10^{2.5} dPa · s (° C.) | 1570 | 1570 | 1520 | 1530 | 1333 |
| Liquidus temperature | — | 1050 | 950 | — | 990 |
| (° C.) | | | | | |
| Liquidus viscosity | — | 6.3 | 6.3 | — | 4.3 |
| (dPa · s) | | | | | |
| Young's modulus | 71 | 69 | 65 | 75 | 77 |
| (GPa) | | | | | |
| Surface roughness Ra | 2 | 2 | 2 | 2 | 110 |
| (Å) | | | | | |
| Surface roughness Rp | 3 | 3 | 3 | 3 | — |
| (Å) | | | | | |
| Surface roughness | 2 | 2 | 2 | 2 | — |
| Rku | | | | | |
| Volume resistivity | 11 | 12 | 12 | 11 | 5 |
| Logρ (Ω · cm) 350° C. | | | | | |
| Water vapor | 0.000001 | 0.000001 | 0.000001 | 0.000001 | — |
| permeation rate | or less | or less | or less | or less | |
| (g/(m² · day)) | | | | | |
| Oxygen permeation | 0.1 or | 0.1 or | 0.1 or | 0.1 or | — |
| rate (g/(m² · day)) | less | less | less | less | |
| Surface projection | 0 | 0 | 0 | 0 | >10 |
| (piece/m²) | | | | | |

Each sample listed in Tables 1 and 2 was produced in the following manner. First, raw glass materials were blended so that each of the glass compositions in the tables was attained. After that, the blended raw glass materials were loaded into a platinum pot and were melted at 1580° C. for 8 hours. Next, the molten glass was poured on a carbon plate and formed into a flat sheet shape. The resultant glass was measured for the following characteristics.

The density is a value obtained by measurement using the known Archimedes' method.

The thermal expansion coefficient α is the average value of the values obtained by measurement in the temperature range of 30 to 380° C. using a dilatometer.

The strain point Ps and the annealing point Ta are values obtained by measurement based on a method of ASTM C336.

The softening point Ts is a value obtained by measurement based on a method of ASTM C338.

The temperatures at a viscosity of 10^{4.0} dPa·s, 10^{3.0} dPa·s, and 10^{2.5} dPa·s are values obtained by measurement using the platinum sphere pull up method.

The Liquidus temperature TL is a value obtained by measuring a temperature at which crystals of glass are deposited after pulverized glass powders that passed through a standard 30-mesh sieve (having a sieve mesh size of 500 μm) and remained on a 50-mesh sieve (having a sieve mesh size of 300 μm) are placed in a platinum boat and kept for 24 hours in a gradient heating furnace.

The liquidus viscosity Log ηTL is a value obtained by measuring the viscosity of glass at a liquidus temperature using the platinum sphere pull up method.

The Young's modulus is a value obtained by measurement using a bending resonance method.

The Sample Nos. 1 to 10 in Tables 1 and 2 were also produced in the following manner. First, raw glass materials were blended so that each of the glass compositions in the tables was attained. After that, the blended raw glass materials were loaded into a melting apparatus 14 as shown in FIG. 2 and were melted at 1500 to 1600° C. Subsequently, the molten glass was subjected to fining in a fining apparatus 15, and then sent to a forming apparatus 18, which was the overflow down-draw apparatus as shown in FIG. 1, via a stirring apparatus 16 and a feeding apparatus 17 to be formed into glass film. During the forming of the glass film, flow rate of the molten glass fed to the forming trough and the temperature of the forming trough were controlled so that the glass film had a thickness of 100 μm. The resultant glass film was evaluated for the following characteristics. As for Sample No. 11, a flat-sheet-shape glass (having a thickness of 700 μm) was produced by a float method.

The surface roughness (Ra, Rp, or Rku) is a value obtained by measurement using a method in accordance with JIS B0601: 2001.

The volume resistivity log ρ is a value obtained by measurement based on a method of ASTM C657.

The surface projection is a value obtained by the following process. That is, while a glass film is irradiated with light of a fluorescent lamp in a dark room, rough visual inspection is performed using the reflected light. After that, a contact-type roughness meter is used to measure the height of profile peaks of a surface within a length of 1000 μm, and then, the number of profile peaks having a height difference (height of profile peak) of 1 μm or more between the tip of the profile peak and the surface (mean line) of the glass film is counted, and the resultant number is converted to the number per m² to calculate the value.

The water vapor permeation rate is a value evaluated using a calcium method.

The oxygen permeation rate is a value evaluated using differential pressure-type gas chromatography (in accordance with JIS K7126).

As evident from Tables 1 and 2, because Sample Nos. 1 to 10 had a thickness of 100 μm, each of these samples had flexibility, and had good surface precision or the like and exhibited a low water vapor permeation rate and a low oxygen permeation rate, with no surface projection observed. Each of the glass films obtained in the experiments is thus considered to be suitably applicable to a lithium ion battery having flexibility. On the other hand, Sample No. 11 was large in surface roughness and had surface projections in large numbers.

Each of the glass films for a lithium ion battery (which were adjusted so as to have a thickness of 30 μm) as Sample Nos. 1 to 10 was used to produce a lithium ion battery. That is, an electrode material was formed on the glass film for a lithium ion battery, and then, on the resultant, a positive electrode material layer, an electrolyte layer, and a negative electrode material were formed to produce the lithium ion battery. The lithium ion battery thus obtained was joined with the power source portion of an OLED panel (3 inches and 0.3 mm in thickness), followed by bonding with a resin, to produce an OLED panel having a thickness (including the power source portion) of 0.4 mm. It should be noted that such the OLED panel could be curved so as to have up to a curvature radius of about 130 mm.

Further, each of the glass films for a lithium ion battery (which were adjusted so as to have a thickness of 30 μm) as Sample Nos. 1 to 10 was used to produce a lithium ion battery. That is, an electrode material was formed on the glass film for a lithium ion battery, and then, on the resultant, a positive electrode material layer, an electrolyte layer, and a negative electrode material were formed to produce the lithium ion battery. The lithium ion battery thus obtained was joined with the power source portion of a thin-film silicon solar cell, followed by bonding with a resin. When the complex solar cell thus produced was irradiated with solar light, the lithium ion battery was charged.

### Example 2

Each of the glass films for a lithium ion battery (which were adjusted so as to have a thickness of 50 μm) as Sample Nos. 1 to 10 was mounted on the surface of a supporting glass sheet (made of alkali-free glass OA-10G, having a thickness of 0.7 mm and a surface roughness (Ra) of 2 Å, and manufactured by Nippon Electric Glass Co., Ltd.), and both were fixed to each other without using an adhesive or the like. Next, after an FTO film was formed on each of the glass films for a lithium ion battery at a film formation temperature of 550° C., a thin-film compound solar cell was formed on the FTO film. Subsequently, on the thin-film compound solar cell, a positive electrode material layer, an electrolyte layer, and a negative electrode material were formed to produce a lithium ion battery, and then the supporting glass sheet was detached to produce a complex solar cell. It should be noted that the complex solar cell could be curved so as to have up to a curvature radius of about 130 mm. Further, when the complex solar cell produced was irradiated with solar light from the glass film side, the lithium ion battery was charged.

### REFERENCE SIGNS LIST

11 trough-shaped refractory
12 molten glass
13 glass film
14 melting apparatus
15 fining apparatus
16 stirring apparatus
17 feeding apparatus
18 forming apparatus

1. A glass film for a lithium ion battery, wherein the glass film has a thickness of 300 μm or less and a surface roughness (Ra) of 100 Å or less.

2. The glass film for a lithium ion battery according to claim 1, wherein the glass film has a surface roughness (Rp) of 10000 Å or less.

3. The glass film for a lithium ion battery according to claim 1, wherein the glass film has a surface roughness (Rku) of 3 or less.

4. The glass film for a lithium ion battery according to claim 1, wherein the glass film has an unpolished surface.

5. The glass film for a lithium ion battery according to claim 1, wherein the glass film has a volume resistivity log ρ at 350° C. of 5.0Ω·cm or more.

6. The glass film for a lithium ion battery according to claim 1, wherein the glass film has a strain point of 500° C. or more.

7. The glass film for a lithium ion battery according to claim 1, wherein the glass film has a thermal expansion coefficient at 30 to 380° C. of 30 to 100×10⁻⁷/° C.

8. The glass film for a lithium ion battery according to claim 1, wherein the glass film has a density of 3.0 g/cm³ or less.

9. The glass film for a lithium ion battery according to claim 1, wherein the glass film has a liquidus temperature of 1200° C. or less and/or a liquidus viscosity of 10^{4.5} dPa·s or more.

10. The glass film for a lithium ion battery according to claim 1, wherein the glass film has a temperature at a viscosity of 10^{2.5} dPa·s of 1650° C. or less.

11. The glass film for a lithium ion battery according to claim 1, wherein the glass film has a film area of 0.1 m² or more and has two or less surface projections per m².

12. The glass film for a lithium ion battery according to claim 1, wherein the glass film has a water vapor permeation rate of 1 g/(m²·day) or less.

13. The glass film for a lithium ion battery according to claim 1, wherein the glass film has an oxygen permeation rate of 1 cc/(m²·day) or less.

14. The glass film for a lithium ion battery according to claim 1, wherein the glass film is formed by an overflow down-draw method.

15. The glass film for a lithium ion battery according to claim 1, wherein the glass film is formed by a slot down-draw method.

16. The glass film for a lithium ion battery according to claim 1, wherein the glass film is rolled into a roll shape.

17. The glass film for a lithium ion battery according to claim 1, wherein the glass film is fixed onto a supporting glass sheet having a thickness of 0.3 mm or more.

18. A lithium ion battery, comprising the glass film for a lithium ion battery according to claim 1.

19. A complex battery, wherein the lithium ion battery according to claim 18 is integrated with a solar cell.

20. The complex battery according to claim 19, wherein the solar cell is a thin-film solar cell.

21. An OLED device, comprising the lithium ion battery according to claim 18.
